(19) United States
(12) Patent Application Publication
(10) Pub. No.: US 2016/0150470 A1
(43) Pub. Date: May 26, 2016

(54) BASE STATION AND COMMUNICATION CONTROL METHOD

(71) Applicant: KYOCERA CORPORATION, Kyoto (JP)

(72) Inventor: Masato FUJISHIRO, Yokohama-shi (JP)

(73) Assignee: KYOCERA CORPORATION, Kyoto (JP)

(21) Appl. No.: 14/906,362

(22) PCT Filed: Aug. 5, 2014
(86) PCT No.: PCT/JP2014/070586

§ 371 Date: Jan. 20, 2016

(30) Foreign Application Priority Data
Aug. 8, 2013 (JP) 2013-164886

(51) Int. Cl. H04W 52/02; H04W 36/00

(52) U.S. Cl. CPC H04W 52/0206; H04W 36/0055

(57) ABSTRACT

A base station (eNB 200-1) according to a first aspect is a base station for use in a mobile communication system. The base station includes a controller configured to perform an energy saving operation for reducing power consumption of the base station while enabling communication between the base station and user terminals connected to the base station. Prior to performing the energy saving operation, the controller transmits, to a neighboring base station (eNB 200-2), an energy saving transition notice (Cell Transition Indication) that indicates transition to the energy saving operation.

### TECHNICAL FIELD

The present invention relates to a base station and communication control method for use in a mobile communication system.

### BACKGROUND ART

The 3rd Generation Partnership Project (3GPP), which is a standardization project for a mobile communication system, employs an energy saving technique for reducing the power consumption of a base station (see, e.g., Non Patent Literature 1). For example, this technique enables power consumption reduction of a base station by halting operation of a cell managed by the base station while the communication traffic volume is small, e.g., during nighttime.

### CITATION LIST

### Non Patent Literature

Non Patent Literature 1: 3GPP Technical Report: “TR 36.927 V11.0.0,” September 2012

### SUMMARY OF INVENTION

The power consumption of a base station can be reduced by halting operation of a cell managed by the base station, but the cell cannot communicate with user terminal in the cell. It is difficult to achieve energy saving of a base station while restraining deterioration of the service quality.

The present invention is directed to enabling energy saving of a base station while restraining deterioration of the service quality.

A base station according to a first aspect is a base station for use in a mobile communication system. The base station includes a controller configured to perform an energy saving operation for reducing power consumption of the base station while enabling communication between the base station and user terminals connected to the base station. Prior to performing the energy saving operation, the controller transmits, to a neighboring base station, an energy saving transition notice that indicates transition to the energy saving operation.

A base station according to a second aspect is a base station for use in a mobile communication system. The base station includes a receiver configured to receive, from a neighboring base station, an energy saving transition notice that indicates transition to an energy saving operation for reducing power consumption of the neighboring base station before the neighboring base station performs the energy saving operation while enabling commination between the neighboring base station and user terminals connected the neighboring base station.

A communication control method according to a third aspect is a method for use in a mobile communication system. The communication control method includes transmitting, from a base station to a neighboring base station, an energy saving transition notice that indicates transition to an energy saving operation before the base station performs the energy saving operation. The energy saving operation is an operation for reducing power consumption of the base station while enabling commination between the base station and user terminals connected the base station.

### BRIEF DESCRIPTION OF DRAWINGS

FIG. 1 is a configuration diagram illustrating an LTE system (mobile communication system) according to first and second embodiments.

FIG. 2 is a block diagram illustrating a UE (user terminal) according to the first and second embodiments.

FIG. 3 is a block diagram illustrating an eNB (base station) according to the first and second embodiments.

FIG. 4 is a protocol stack diagram illustrating a radio interface according to the first and second embodiments.

FIG. 5 is a configuration diagram illustrating a radio frame according to the first and second embodiments.

FIG. 6 is a diagram illustrating an energy saving technique (part 1).

FIG. 7 is a diagram illustrating an energy saving technique (part 2).

FIG. 8 is a diagram illustrating an operation environment according to the first and second embodiments.

FIG. 9 is a diagram illustrating discontinuous transmission as one example energy saving method according to the first and second embodiments.

FIG. 10 is a diagram illustrating reduction of the number of transmission antennas as one example energy saving method according to the first and second embodiments.

FIG. 11 is a diagram illustrating an operation sequence according to the first embodiment.

FIG. 12 is a diagram illustrating an operation sequence according to the second embodiment.

FIG. 13 is a diagram illustrating an operation sequence diagram according to a modification of the second embodiment.

### DESCRIPTION OF EMBODIMENTS

### Overview of Embodiments

A base station according to first and second embodiments is a base station for use in a mobile communication system. The base station includes a controller configured to perform an energy saving operation for reducing power consumption of the base station while enabling communication between the base station and user terminals connected to the base station. Prior to performing the energy saving operation, the controller transmits, to a neighboring base station, an energy saving transition notice that indicates transition to the energy saving operation.

In the first and second embodiments, the energy saving transition notice is used as a trigger for restraining handover of user terminal from the neighboring base station to the base station, at the neighboring base station.

In the first and second embodiments, the energy saving operation includes a transition operation that gradually reduces the power consumption of the base station while handover of the user terminals from the base station to the neighboring base station is performed in order.

In the first embodiment, after starting the transition operation, the controller ends the transition operation based on an increase in a load level of the neighboring base station and transmits, to the neighboring base station, a transition end notice that indicates an end of the transition operation.

In the first embodiment, in the energy saving operation after the end of the transition operation, the controller maintains a power consumption state of the base station as of the end of the transition operation.

In the first embodiment, the transition end notice is used as a trigger for cancelling restraint of handover of user terminal from the neighboring base station to the base station, at the neighboring base station.

In the second embodiment, in the transition operation, the controller adjusts a handover parameter to be applied to the user terminals connected to the base station and thereby in order performs handover of the user terminals from the base station to the neighboring base station.

In the second embodiment, the controller includes, in the energy saving transition notice, the handover parameter to be applied to the user terminals connected to the base station and transmits the energy saving transition notice to the neighboring base station.

A base station according to first and second embodiments is a base station for use in a mobile communication system. The base station includes a receiver configured to receive, from a neighboring base station, an energy saving transition notice that indicates transition to an energy saving operation for reducing power consumption of the neighboring base station before the neighboring base station performs the energy saving operation while enabling commination between the neighboring base station and user terminals connected the neighboring base station.

In the first and second embodiments, the base station further includes a controller configured to, upon receipt of the energy saving transition notice from the neighboring base station by the receiver, perform control to restrain handover of user terminal from the base station to the neighboring base station.

In the first and second embodiments, the energy saving operation includes a transition operation that gradually reduces the power consumption of the neighboring base station while handover of the user terminals from the neighboring base station to the base station is performed in order. The receiver further receives, from the neighboring base station, a transition end notice that indicates an end of the transition operation.

In the first embodiment, the controller is configured to, upon receipt of the transition end notice from the neighboring base station by the receiver, cancel restraint of handover of user terminal from the base station to the neighboring base station.

In the second embodiment, the energy saving transition notice includes a handover parameter to be applied to the user terminals connected to the neighboring base station. The controller applies, to user terminal connected to the base station, the handover parameter included in the energy saving transition notice.

A communication control method according to first and second embodiments is a method for use in a mobile communication system. The communication control method includes transmitting, from a base station to a neighboring base station, an energy saving transition notice that indicates transition to an energy saving operation before the base station performs the energy saving operation. The energy saving operation is an operation for reducing power consumption of the base station while enabling commination between the base station and user terminals connected the base station.

### First Embodiment

An embodiment of applying the present invention to an LTE system is hereinafter described.

(System Architecture)

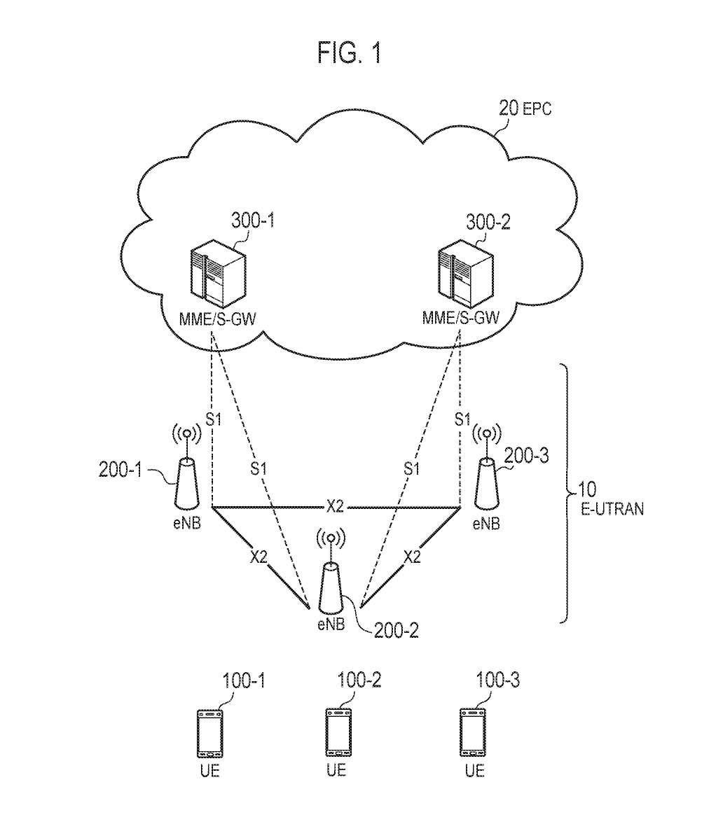

FIG. 1 is an architecture diagram of the LTE system according to a first embodiment. As illustrated in FIG. 1, the LTE system according to the first embodiment includes UE (User Equipment) 100, E-UTRAN (Evolved-UMTS Terrestrial Radio Access Network) 10, and EPC (Evolved Packet Core) 20.

The UE 100 corresponds to a user terminal. The UE 100 is a mobile communication device, which performs radio communication with a cell (a serving cell) with which a connection is established. The architecture of the UE 100 will be described later.

The E-UTRAN 10 corresponds to a radio access network. The E-UTRAN 10 includes eNB 200 (evolved Node-B). The eNB 200 corresponds to a base station. The eNBs 200 are connected mutually via an X2 interface. The architecture of the eNB 200 will be described later.

The eNB 200 manages one or a plurality of cells, and performs radio communication with the UE 100 that establishes a connection with a cell of the eNB 200. The eNB 200 has a radio resource management (RRM) function, a routing function of user data, a measurement control function for mobility control and scheduling and the like. The “cell” is used as a term indicating a smallest unit of a radio communication area, and is also used as a term indicating a function of performing radio communication with the UE 100.

The EPC 20 corresponds to a core network. A network of the LTE system is configured by the E-UTRAN 10 and the EPC 20. The EPC 20 includes MME (Mobility Management Entity)/S-GW (Serving-Gateway) 300. The MME performs different types of mobility control and the like for the UE 100. The SGW performs transfer control of the user data. The MME/S-GW 300 is connected to the eNB 200 via an S1 interface.

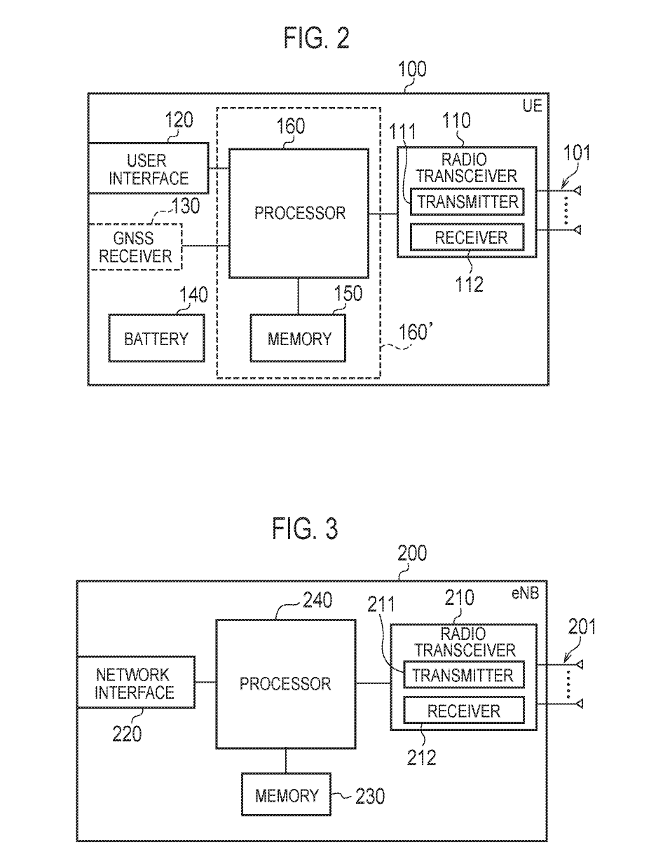

FIG. 2 is a block diagram of the UE 100. As illustrated in FIG. 2, the UE 100 includes plural antennas 101, a radio transceiver 110, a user interface 120, a GNSS (Global Navigation Satellite System) receiver 130, a battery 140, a memory 150, and a processor 160. The memory 150 and the processor 160 configure a controller of the UE 100. The UE 100 may not necessarily include the GNSS receiver 130. Furthermore, the memory 150 may be integrally formed with the processor 160, and this set (that is, a chip set) may be called a processor 160′.

The plural antennas 101 and the radio transceiver 110 are used to transmit and receive a radio signal. The radio transceiver 110 includes a transmitter 111 that converts a baseband signal (a transmission signal) output from the processor 160 into a radio signal, and transmits the radio signal from the plural antennas 101. Furthermore, the radio transceiver 110 includes a receiver 112 that converts a radio signal received by the plural antennas 101 into a baseband signal (a reception signal), and outputs the baseband signal to the processor 160.

The user interface 120 is an interface with a user carrying the UE 100, and includes, for example, a display, a microphone, a speaker, various buttons and the like. The user interface 120 receives an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates a power to be supplied to each block of the UE 100.

The memory 150 stores a program to be executed by the processor 160 and information to be used for processing by the processor 160. The processor 160 includes a baseband processor that performs modulation and demodulation, encoding and decoding and the like on the baseband signal, and a CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes plural antennas 201, a radio transceiver 210, a network interface 220, a memory 230, and a processor 240. The memory 230 and the processor 240 configure a controller of the eNB 200.

The plural antennas 201 and the radio transceiver 210 are used to transmit and receive a radio signal. The radio transceiver 210 includes a transmitter 211 that converts a baseband signal (a transmission signal) output from the processor 240 into a radio signal, and transmits the radio signal from the plural antennas 201. Furthermore, the radio transceiver 210 includes a receiver 212 that converts a radio signal received by the plural antennas 201 into a baseband signal (a reception signal), and outputs the baseband signal to the processor 240.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for processing by the processor 240. The processor 240 includes a baseband processor that performs modulation and demodulation, encoding and decoding and the like on the baseband signal and a CPU that performs various processes by executing the program stored in the memory 230. The processor 240 executes various processes and various communication protocols described later.

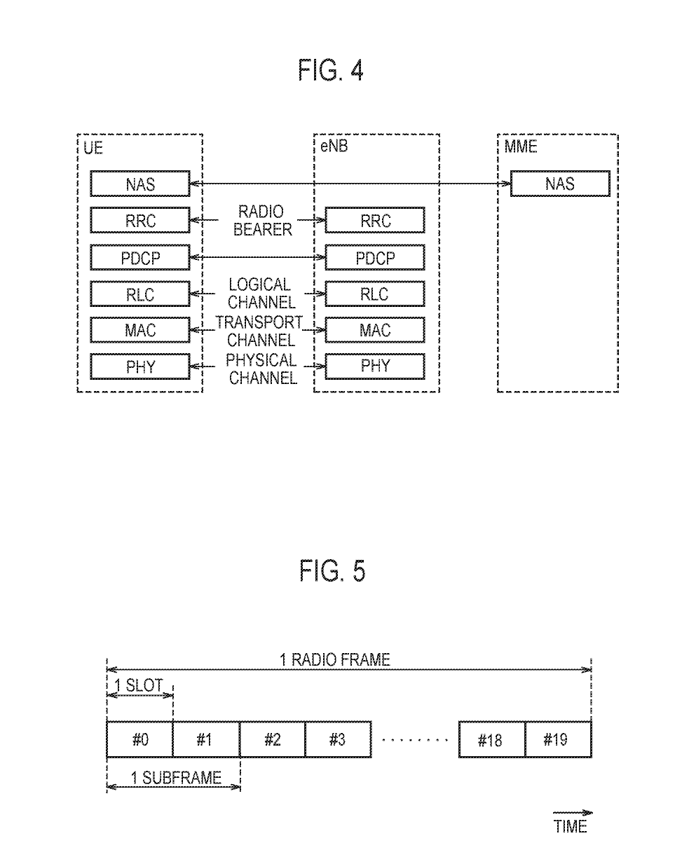

FIG. 4 is a protocol stack diagram of a radio interface in the LTE system. As illustrated in FIG. 4, the radio interface protocol is classified into a first layer to a third layer of an OSI reference model, such that the first layer is a physical (PHY) layer. The second layer includes a MAC (Medium Access Control) layer, an RLC (Radio Link Control) layer, and a PDCP (Packet Data Convergence Protocol) layer. The third layer includes an RRC (Radio Resource Control) layer.

The physical layer performs encoding and decoding, modulation and demodulation, antenna mapping and demapping, and resource mapping and demapping. Between the physical layer of the UE 100 and the physical layer of the eNB 200, user data and control signals are transmitted via a physical channel

The MAC layer performs priority control of data, and a retransmission process and the like by a hybrid ARQ (HARQ). Between the MAC layer of the UE 100 and the MAC layer of the eNB 200, user data and control signals are transmitted via a transport channel. The MAC layer of the eNB 200 includes a scheduler for determining (scheduling) a transport format (a transport block size and a modulation and coding scheme) of an uplink and a downlink, and resource blocks to be assigned to the UE 100.

The RLC layer transmits data to an RLC layer of a reception side by using the functions of the MAC layer and the physical layer. Between the RLC layer of the UE 100 and the RLC layer of the eNB 200, user data and control signals are transmitted via a logical channel.

The PDCP layer performs header compression and decompression, and encryption and decryption.

The RRC layer is defined only in a control plane that handles control signals. Between the RRC layer of the UE 100 and the RRC layer of the eNB 200, a control signal (an RRC message) for various types of configurations is transmitted. The RRC layer controls the logical channel, the transport channel, and the physical channel according to the establishment, re-establishment, and release of a radio bearer. When there is a connection (an RRC connection) between the RRC of the UE 100 and the RRC of the eNB 200, the UE 100 is in a connected state (RRC connected state). Otherwise, the UE 100 is in an idle state (RRC idle state).

An NAS (Non-Access Stratum) layer positioned above the RRC layer performs session management, mobility management and the like.

FIG. 5 is a configuration diagram of a radio frame used in the LTE system. In the LTE system, OFDMA (Orthogonal Frequency Division Multiple Access) is applied to a downlink (DL), and SC-FDMA (Single Carrier Frequency Division Multiple Access) is applied to an uplink (UL), respectively.

As illustrated in FIG. 5, a radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each of the resource blocks includes a plurality of subcarriers in the frequency direction. A resource element is configured by one subcarrier and one symbol.

Among the radio resources assigned to the UE 100, a frequency resource is configured by a resource block, and a time resource is configured by a subframe (or a slot).

In the downlink, an interval of several symbols at the head of each subframe is a region used as a physical downlink control channel (PDCCH) for mainly transmitting a downlink control signal. Furthermore, the remaining portion of each subframe is a region available as a physical downlink shared channel (PDSCH) for mainly transmitting downlink user data.

In the uplink, both ends in the frequency direction of each subframe are regions used as a physical uplink control channel (PUCCH) for mainly transmitting an uplink control signal. The remaining portion of each subframe is a region available as a physical uplink shared channel (PUSCH) for mainly transmitting uplink user data.

(Energy Saving Technique)

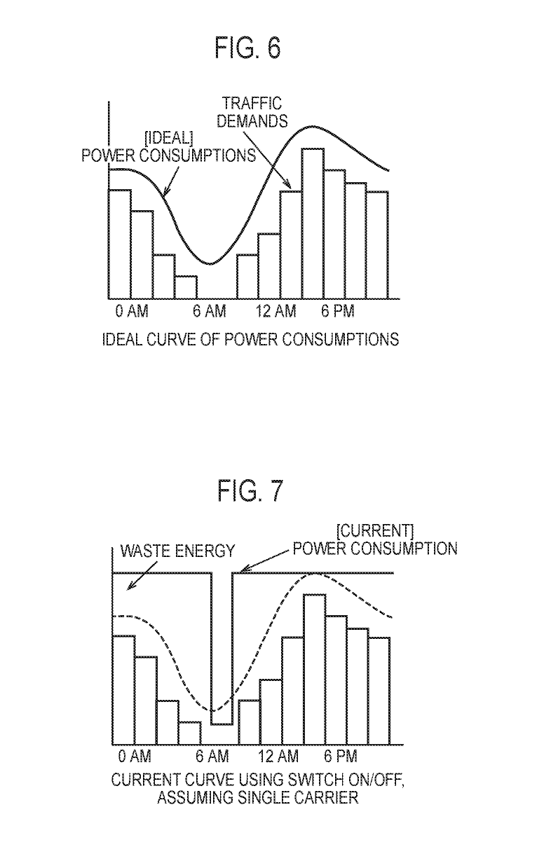

The LTE system employs an energy saving technique for reducing the power consumption of the eNB 200. FIGS. 6 and 7 are diagrams illustrating the energy saving technique.

As illustrated in FIG. 6, the communication traffic volume handled by the eNB 200 (specifically, user data transmitted and received between the eNB 200 and the UE 100) changes over time. In the example of FIG. 6, the communication traffic volume handled by the eNB 200 is zero in the early morning. The traffic volume increases in the afternoon and early in the evening and decreases at night and midnight. It is ideal that the power consumption of the eNB 200 changes as the communication traffic changes.

As illustrated in FIG. 7, the current energy saving technique specifies only whether operation of a cell managed by the eNB 200 should be halted—specifically, only switching on or off the cell. A gradual change of the power consumption of the eNB 200 is not possible. In the example of FIG. 7, the eNB 200 switches the cell off during a time period with no communication traffic and switches the cell on during the other time period. There are only two states: a state of small power consumption and a state of large power consumption. The power consumption is more wasteful compared with ideal power consumption.

### Operation According to First Embodiment

The operation according to a first embodiment is hereinafter described. In the first embodiment, the operation for specifically controlling the power consumption of the eNB 200 is described.

(1) Overview of Operation

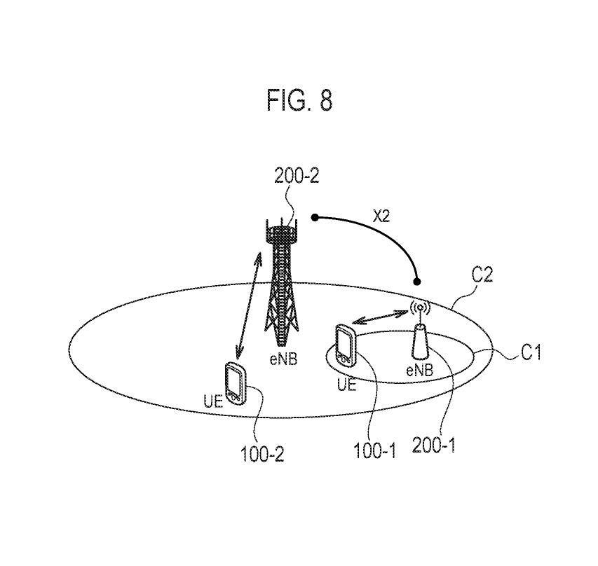

FIG. 8 is a diagram illustrating the operation environment according to the first embodiment. A heterogeneous network consisting of the eNB 200 with different types of cell is used as an example for illustration of the first embodiment. However, it should be noted that the present invention is not limited to a heterogeneous network.

As illustrated in FIG. 8, an eNB 200-1 is a type of the eNB 200 that manages a small cell C1. The small cell C1 is, e.g., a pico cell or femtocell which is a type of cell smaller than a macrocell. An UE 100-1 is in a state of having established connection (connection state) with the small cell C1 managed by the eNB 200-1. FIG. 8 illustrates only one the UE 100-1, but in an actual operation environment, a plurality of the UEs 100-1 are in a connection state with the small cell C1.

An eNB 200-2 is a type of the eNB 200 that manages a macrocell C2. The macrocell C2 is an ordinary large-sized cell in the LTE system. An UE 100-2 is in a state of having established connection (connection state) with the macrocell C2 managed by the eNB200-2. FIG. 8 illustrates only one the UE 100-2, but in an actual operation environment, a plurality of the UEs 100-2 are in a connection state with the macrocell C2.

The small cell C1 is provided in the macrocell C2. The eNB 200-1 and the eNB 200-2 neighbor each other, and an X2 interface is established between the eNB 200-1 and the eNB 200-2. The eNB 200-1 and the eNB 200-2 can perform communication via the X2 interface. Alternatively, the eNB 200-1 and the eNB 200-2 may perform communication via an S1 interface.

The eNB 200-1 performs an energy saving operation for reducing the power consumption of the eNB 200-1 while enabling communication with the UE 100-1, which is connected with the eNB 200-1. A specific example of the energy saving operation is described below. Prior to performing the energy saving operation, the eNB 200-1 transmits, to the eNB 200-2, an energy saving transition notice, which indicates transition to the energy saving operation. The eNB 200-2 receives the energy saving transition notice from the eNB 200-1. Thereby, the eNB 200-2 can in advance know transition of the eNB 200-1 to the energy saving operation.

The eNB 200-2 uses the energy saving transition notice as a trigger for restraining handover of the UE 100-2 from the eNB 200-2 to the eNB 200-1. Upon receipt of the energy saving transition notice from the eNB 200-1, the eNB 200-2 performs control to restrain handover of the UE 100-2 from the eNB 200-2 to eNB200-1.

In this way, by restraining handover of the UE 100-2 to the eNB 200-1 that is in transition to the energy saving operation, the eNB 200-1 can efficiently make the transition to the energy saving operation. After the UE 100-1 is handed over to the eNB 200-2, the UE 100-1 can be prevented from being handed over to the eNB 200-1 again (i.e., a ping-pong handover).

The energy saving operation includes a transition operation for gradually decreasing the power consumption of the eNB 200-1 while performing handover of the UE 100-1 to the eNB 200-2 in order. To an extent where the eNB 200-2 can no longer accept the UE 100-1, the power consumption of the eNB 200-1 can be gradually decreased.

After starting the transition operation, the eNB 200-1 ends the transition operation based on an increase in the load level of the eNB 200-2 and transmits, to the eNB 200-2, a transition end notice that indicates the end of the transition operation. The eNB 200-2 uses the transition end notice as a trigger for cancelling the restraint of handover of the UE 100 from the eNB 200-2 to the eNB 200-1. Upon reception of the transition end notice from the eNB 200-1, the eNB 200-2 cancels the restraint of handover of the UE 100 from the eNB 200-2 to the eNB 200-1.

In the energy saving operation subsequent to the end of the transition operation, the eNB 200-1 maintains the power consumption state of the eNB 200-1 as of the end of the transition operation. The power consumption of the eNB 200-1 can thereby be set to an optimum level.

(2) Energy Saving Operation

The first embodiment uses a plurality of energy saving methods (energy saving modes), each of which is different in terms of how to reduce the power consumption. By combining a plurality of energy saving methods, the power consumption of the eNB 200 can be gradually reduced.

Types of energy saving methods include “discontinuous transmission (DTX),” “number of transmission antennas reduction (ANT reduced),” “transmission power reduction (TxPower reduced),” and “communication capacity reduction (Capacity reduced).”

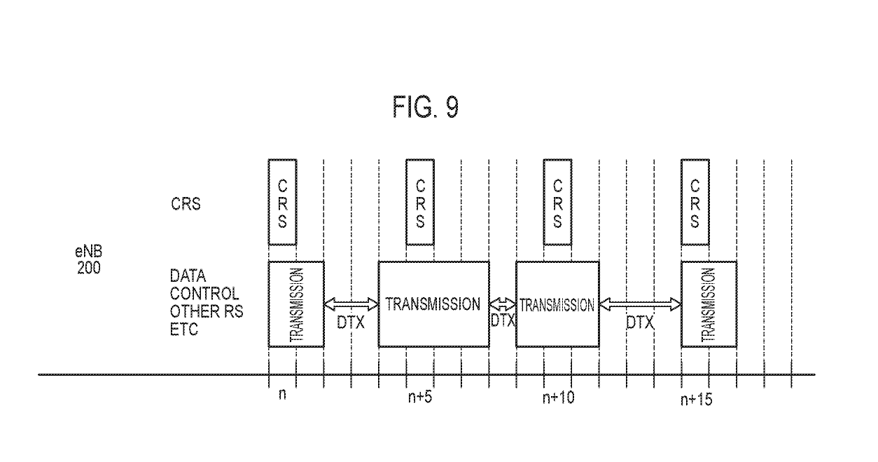

The discontinuous transmission is an energy saving method whereby the eNB 200 discontinuously transmits a radio signal. FIG. 9 is a diagram illustrating discontinuous transmission. As illustrated in FIG. 9, the eNB 200 discontinuously transmits a cell-specific reference signal (CRS). In the example of FIG. 9, one CRS is transmitted in every five subframes. The eNB 200 sets a transmission halt section (DTX section) in a period (subframe) when a CRS is not transmitted. In the transmission halt section, power supply to a transmitter 211 (power amplifier, in particular) of the eNB 200 can be halted, and energy saving can be achieved accordingly.

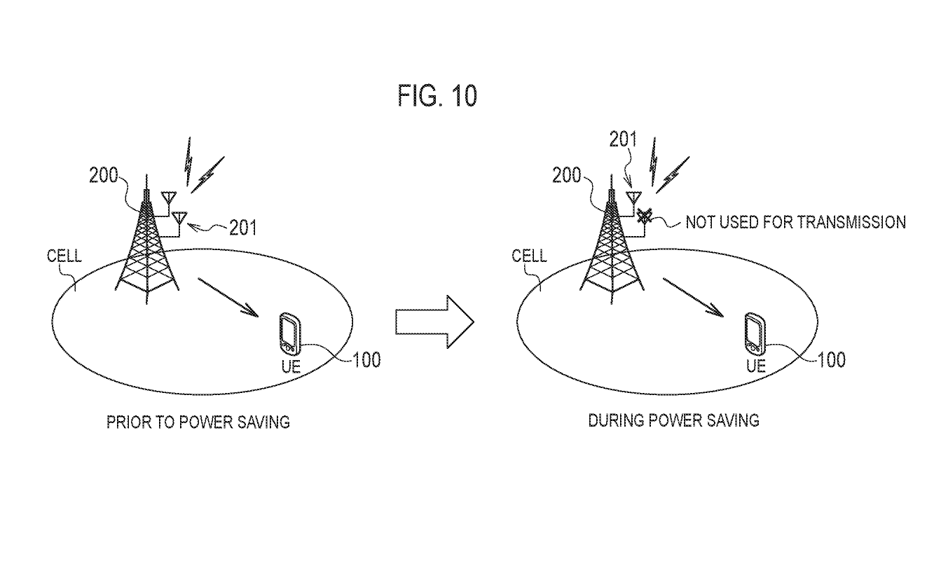

The number of transmission antennas reduction is an energy saving method for reducing the number of antennas that the eNB 200 uses for radio signal transmission (hereinafter referred to as “number of used antennas”). FIG. 10 is a diagram illustrating the number of transmission antennas reduction. As illustrated in FIG. 10, the eNB 200 only uses a part of the plurality of antennas 201 for radio signal transmission. By reducing the number of used antennas, the power consumption of the eNB 200 (the transmitter 211, in particular) decreases, and energy saving can be achieved accordingly.

Transmission power reduction is an energy saving method whereby the eNB 200 redundantly transmits transmission data using a surplus radio resource while reducing the transmission power. By reducing the transmission power, the power consumption of the eNB 200 (the transmitter 211, in particular) decreases, and energy saving of the eNB 200 can be achieved accordingly.

Communication capacity reduction is an energy saving method for limiting the number of the eNB 200-connectable UEs or the radio resource volume that can be allocated by the eNB 200. By implementing such a limitation, the power consumption of the eNB 200 (processor 240, in particular) decreases, and energy saving of the eNB 200 can be achieved accordingly.

In addition to the aforementioned energy saving methods, the following energy saving methods described in 1) to 3) may be adopted:

1) Use of MBSFN or ABS: setting an MBSFN (MBMS Single Frequency Network) subframe or an ABS (Almost Blank Subframe) subframe, where transmission is halted in the subframe.

2) Use of TDD DwPTS in Special Subframe: setting, to the shortest time period, DwPTS in Special Subframe included in a TDD radio frame and halting transmission other than during the DwPTS period.

3) Use of TDD dynamic frame configuration: creating a TDD frame setting (config.) where a downlink transmission subframe is the smallest and halting transmission during an uplink time.

(3) Operation Sequence

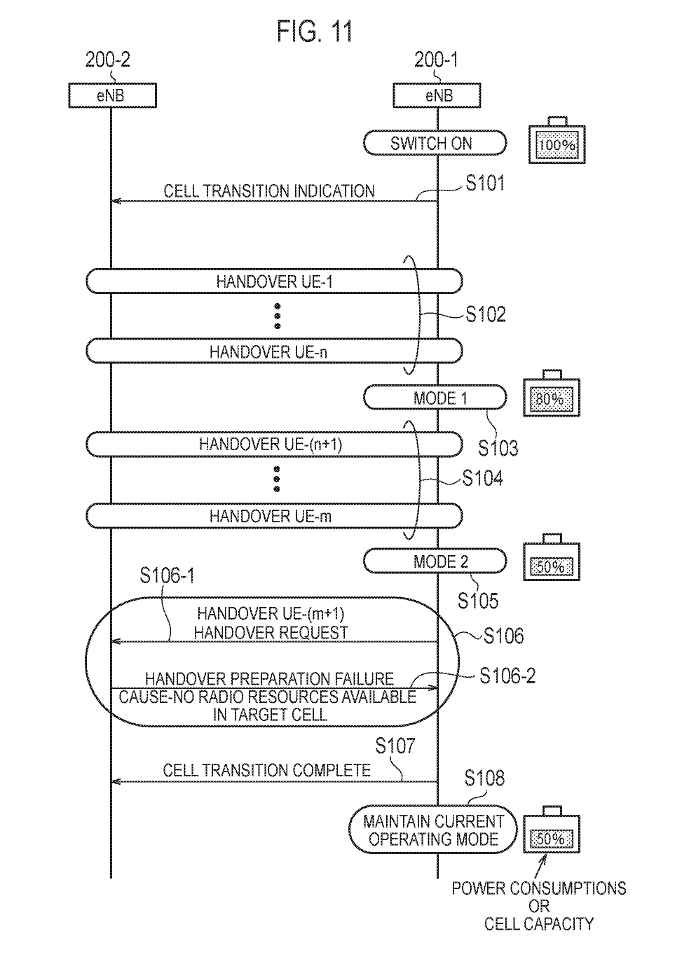

FIG. 11 is an operation sequence diagram according to the first embodiment. In the initial state of FIG. 11, the eNB 200-1 performs ordinary operation.

As illustrated in FIG. 11, the eNB 200-1 determines to make a transition from the ordinary operation to the energy saving operation. For example, when the communication traffic volume handled by a cell of the eNB 200-1 (small cell C1) falls below the threshold value, the eNB 200-1 determines transition to the energy saving operation. Alternatively, the eNB 200-1 may be set so as to in advance store a time period when the communication traffic volume handled by the eNB 200-1 is small so that transition to the energy saving operation is determined based on comparison between the stored time period and the current time of day.

In step S101, prior to performing the energy saving operation, the eNB 200-1 transmits, to the eNB 200-2, an energy saving transition notice (Cell Transition Indication) that indicates transition to the energy saving operation. The energy saving transition notice (Cell Transition Indication) may include a source cell ID and a destination cell ID. Upon reception of the energy saving transition notice (Cell Transition Indication) from the eNB 200-1, the eNB 200-2 performs control to restrain handover of the UE 100-2 to the eNB 200-1. Also, in preparation for handover of the UE 100-1 to a cell (macrocell C2) of the eNB 200-2, the eNB 200-2 monitors the load level of the aforementioned cell.

In step S102, the eNB 200-1 starts the transition operation. Specifically, the eNB 200-1 performs handover of the UE 100-1 to the eNB 200-2. The UEs 100-1 subject to the handover are the UE 1 to n, which account for a part of a plurality of the UEs 100-1. Also, the eNB 200-1 monitors the load level of its own cell (small cell C1) and confirms whether the load level has decreased to a level where the power consumption can be decreased by one level.

In step S103, when the eNB 200-1 confirms that the load level of its own cell (small cell C1) has decreased, the eNB 200-1 performs one of the aforementioned energy saving methods to decrease the power consumption by one level. For example, with reference of the power consumption during the ordinary operation, the power consumption of the eNB 200-1 is reduced down to 80%.

In step S104, the eNB 200-1 performs handover of the UE 100-1 to the eNB 200-2. The UEs 100-1 subject to the handover are the UE (n+1) to m, which account for a part of a plurality of the UEs 100-1. Also, the eNB 200-1 monitors the load level of its own cell (small cell C1) and confirms whether the load level has decreased to a level where the power consumption of the eNB 200-1 can be decreased by another one level.

In step S105, when the eNB 200-1 confirms that the load level of its own cell (small cell C1) has decreased, the eNB 200-1 performs one of the aforementioned energy saving methods to decrease the power consumption by another one level. For example, with reference of the power consumption during the ordinary operation, the power consumption of the eNB 200-1 is reduced down to 50%.

In step S106, the eNB 200-1 attempts handover of the UE 100-1 to the eNB 200-2. However, as the load level of the eNB 200-2 has increased, the handover is rejected by the eNB 200-2.

Specifically, in step S106-1, the eNB 200-1 transmits a handover request to the eNB 200-2 for handover of the UE (m+1). In step S106-2, the eNB 200-2 transmits, to the eNB 200-1, a rejection notice (Handover Preparation Failure) in response to the handover request. The eNB 200-2 includes, in the rejection notice (Handover Preparation Failure), information (“Cause”) that indicates the reason for the handover rejection. The “Cause” means: radio resources are not available (No Radio Resources Available); the capacity of its own cell is insufficient; or the load level has surpassed the threshold value. One example where the “Cause” is “No Radio Resources Available” is hereinafter described.

Upon receipt of the rejection notice (Handover Preparation Failure), the eNB 200-1 determines that no further handover is possible on the basis that the reason for the handover rejection is “No Radio Resources Available” and ends the transition operation. In this way, after start of the transition operation, the eNB 200-1 ends the transition operation based on an increase in the load level of the eNB 200-2. Specifically, the eNB 200-1 gradually decreases its own power consumption until the eNB 200-2 can no longer accept the UE 100-1.

In step S107, the eNB 200-1 transmits, to the eNB 200-2, a transition end notice (Cell State Change Update) that indicates the end of the transition operation. The transition end notice (Cell State Change Update) may include a source cell ID and a destination cell ID. Upon reception of the transition end notice (Cell Transition Complete) from the eNB 200-1, the restraint of handover of the UE 100 from the eNB 200-2 to the eNB 200-1 is cancelled.

In step S108, during the energy saving operation subsequent to the end of the transition operation, the eNB 200-1 maintains its own power consumption at the level as of the end of the transition operation. In an example of this sequence, the eNB 200-1 maintains a state where the power consumption is reduced by two levels (50% the power consumption of the ordinary operation). The power consumption of the eNB 200-1 can be set to an optimal state.

When the volume of the communication traffic handled by the eNB 200-1's own cell (small cell C1) surpasses the threshold value during the energy saving operation, the eNB 200-1 may determine to reinstate the ordinary operation to perform the reinstating operation. In the reinstating operation, an operation whose sequence is opposite of the aforementioned sequence are performed.

### Modification of First Embodiment

According to the first embodiment, on the basis that the reason for handover rejection is “No Radio Resources Available,” the eNB 200-1 having received the rejection notice (Handover Preparation Failure) determines that no further handover is possible and ends the transition operation.

Instead of immediately ending the transition operation, the eNB 200-1 may retry the transition operation upon lapse of a certain time period after having determined that handover is not possible. When the load level of the eNB 200-2 has decreased during the aforementioned certain time period, continuation of the transition operation is possible. The aforementioned certain time period may be set to a constant value or a variable (setting may be made by EPC 20 or the eNB 200-2).

Instead of determining an increase in the load level of the eNB 200-2 based on the rejection notice (Handover Preparation Failure), the Resource Status Reporting procedure (see TS36.423) may be employed to determine an increase in the load level of the eNB 200-2.

Also, upon determination that handover to the eNB 200-2 is not possible, NB200-1 may perform the same operation as the operation for the eNB 200-2 for the eNB that is not the eNB 200-2 and that neighbors the eNB 200-2 (second candidate neighboring the eNB).

### Second Embodiment

The second embodiment is hereinafter described mainly with regard to the differences from the first embodiment. The second embodiment is the same as the first embodiment in terms of the system configuration and operation environment.

### Operation According to Second Embodiment

In the second embodiment, an operation for performing appropriate handover in the transition operation is described.

(1) Overview of Operation

According to the second embodiment, during the transition operation, the eNB 200-1 in order performs handover of the UE 100-1 from the eNB 200-1 to the eNB 200-2 by adjusting the handover parameter to be applied to the UE 100-1. A specific example handover parameter is hereinafter described. By performing handover in order by means of handover parameter adjustment, handover of the UE 100-1 in a bad radio environment (e.g., cell edge the UE) can prioritized.

According to the second embodiment, the eNB 200-1 includes, in the energy saving transition notice (Cell Transition Indication), a handover parameter to be applied to the UE 100-1 and transmits the handover parameter to the eNB 200-2. The eNB 200-2 applies the handover parameter, which is contained in the energy saving transition notice (Cell Transition Indication), to the UE 100-2 connected to the eNB 200-2. Handover of the UE 100-2 to the eNB 200-1 can be thereby restrained.

A request for changing the handover parameter may be included in the energy saving transition notice (Cell Transition Indication) so as to be transmitted to the eNB 200-2. The foregoing is possible other than the situation where the handover parameter is included in the energy saving transition notice (Cell Transition Indication) and transmitted to the eNB 200-2. In this situation, a special handover parameter is in advance shared between the eNB 200-1 and the eNB 200-2. Upon receipt of the request for changing the handover parameter, the eNB 200-2 starts application of the special handover parameter.

(2) Handover Parameter

The handover parameter to be applied to the UE 100-1 is a threshold value (handover threshold value) to be compared with the reception condition measured by the aforesaid the UE 100-1 or an offset value to be added to the reception condition or the handover threshold value. For example, the reception condition measured by the UE 100-1 is the reception signal reception power (RSRP) or the reception signal reception quality (RSRQ) of the eNB 200-1 and/or the eNB 200-2. A specific example of the handover parameter is hereinafter described.

(2.1) Specific Example 1 of Handover Parameter

Here, one example where the handover parameter is an offset value to be added to the reception condition of a serving cell is described. Such a handover parameter is eventually referred to as “event A3 parameter.”

An offset value as a handover parameter is transmitted as setting information from the eNB 200-1 to the UE 100-1, where the handover parameter is used for comparison between the reception conditions of the serving cell and the neighbor cell. For example, the UE 100-1 measures the first RSRP of the eNB 200-1 (serving cell) and the second RSRP of the eNB 200-2 (neighbor cell), and the sum of the first RSRP and the offset value (negative value) is in turn compared with the second RSRP. When the second RSRP is greater, the UE 100-1 transmits, to the eNB 200-1, a measurement report including a measurement result. Upon receipt of the measurement report from the UE 100-1, the eNB 200-1 performs handover of the UE 100-1 to the eNB 200-2. Handover from the eNB 200-1 to the eNB 200-2 is thereby promoted, and the coverage area of the eNB 200-1 can be virtually reduced.

An offset value as a handover parameter is transmitted from the eNB 200-1 to the eNB 200-2, where the offset value is applied to the UE 100-2. Specifically, the offset value is transmitted as setting information from the eNB 200-2 to the UE 100-2, where the offset value is used for comparison between the reception conditions of the serving cell and the neighbor cell. For example, the UE 100-2 measures the first RSRP of the eNB 200-2 (serving cell) and the second RSRP of the eNB 200-1 (neighbor cell), and the sum of the first RSRP and the offset value (positive value) is in turn compared with the second RSRP. When the second RSRP is greater, the UE 100-2 transmits, to the eNB 200-2, a measurement report including a measurement result. Upon receipt of the measurement report from the UE 100-2, the eNB 200-2 performs handover of the UE 100-1 to the eNB 200-1. Handover from the eNB 200-2 to the eNB 200-1 is thereby restrained, and the coverage area of the eNB 200-2 can be virtually enlarged.

(2.2) Specific Example 2 of Handover Parameter

Alternatively, an offset value as a handover parameter is not transmitted to the UE 100-1 from the eNB 200-1, and instead, the offset value is used by the eNB 200-1 for comparison between the reception conditions of the serving cell and the neighbor cell. For example, the UE 100-1 measures the first RSRP of the eNB 200-1 (serving cell) and the second RSRP of the eNB 200-2 (neighbor cell) and periodically transmits, to the eNB 200-1, a measurement report including a measurement result. The eNB 200-1 compares the sum of the first RSRP included in the measurement report from the UE 100-1 and the offset value (negative value) with the second RSRP included in the measurement report. When the second RSRP is greater, the eNB 200-1 performs handover of the UE 100-1 to the eNB 200-2. Handover from the eNB 200-1 to the eNB 200-2 is thereby promoted, and the coverage area of the eNB 200-1 can be virtually reduced.

An offset value as a handover parameter is transmitted from the eNB 200-1 to the eNB 200-2, where the offset value is applied to the UE 100-2. Specifically, the offset value is not transmitted to the UE 100-2 from the eNB 200-2, and instead, the offset value is used by the eNB 200-2 for comparison between the reception conditions of the serving cell and the neighbor cell. For example, the UE 100-2 measures the first RSRP of the eNB 200-2 (serving cell) and the second RSRP of the eNB 200-1 (neighbor cell) and periodically transmits, to the eNB 200-2, a measurement report including a measurement result. The eNB 200-2 compares the sum of the first RSRP included in the measurement report from the UE 100-2 and the offset value (positive value) with the second RSRP included in the measurement report. When the second RSRP is greater, the eNB 200-2 performs handover of the UE 100-2 to the eNB 200-1. Handover from the eNB 200-2 to the eNB 200-1 is thereby restrained, and the coverage area of the eNB 200-2 can be virtually enlarged.

(3) Operation Sequence

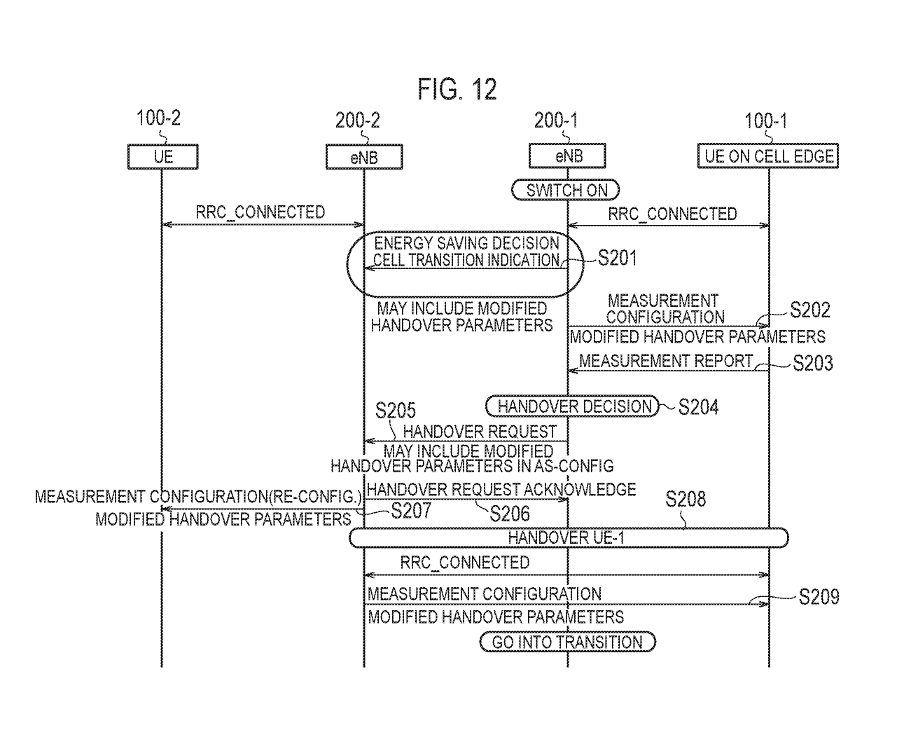

FIG. 12 is an operation sequence diagram according to the second embodiment. Here, aforementioned specific example 1 of the handover parameter is assumed, and any illustration overlapping an illustration of the first embodiment is omitted.

As illustrated in FIG. 12, in step S201, the eNB 200-1 determines transition from the ordinary operation to the energy saving operation. Prior to performing the energy saving operation, the eNB 200-1 transmits, to the eNB 200-2, an energy saving transition notice (Cell Transition Indication) that indicates transition to the energy saving operation. According to the second embodiment, the eNB 200-1 includes, in the energy saving transition notice (Cell Transition Indication), the handover parameter to be applied to the UE 100-1.

In step S202, the eNB 200-1 includes, in setting information (Measurement Configuration), the handover parameter to be applied to the UE 100-1 and transmits the handover parameter to the UE 100-1.

In step S203, the UE 100-1 transmits, to the eNB 200-1, a measurement report including a measurement result based on setting information (Measurement Configuration). For example when the second RSRP of the eNB 200-2 (neighbor cell) is greater than the sum of the first RSRP of the eNB 200-1 (serving cell) and the offset value (negative value), the UE 100-1 transmits, to the eNB 200-1, a measurement report including a measurement result.

In step S204, the eNB 200-1 determines handover of the UE 100-1 to the eNB 200-2 upon receipt of the measurement result from the aforesaid the UE 100-1.

In step S205, the eNB 200-1 transmits, to the eNB 200-2, a handover request for handover of the UE 100-1. The eNB 200-1 may include, in the handover request, the handover parameter to be applied to the UE 100-1.

In step S206, the eNB 200-2 transmits, to the eNB 200-1, an acknowledge notice (Handover Request Acknowledge) in response to the handover request.

In step S207, the eNB 200-2 includes, in setting information (Measurement Configuration), the handover parameter notified from the eNB 200-1 and transmits the handover parameter to the UE 100-2.

In step S208, the eNB 200-1 performs handover of the UE 100-1 to the eNB 200-2, whereby the UE 100-1 establishes connection with the eNB 200-2.

In step S209, the eNB 200-2 includes, in setting information (Measurement Configuration), the handover parameter notified from the eNB 200-1 and transmits the handover parameter to the UE 100-1.

### Modification of Second Embodiment

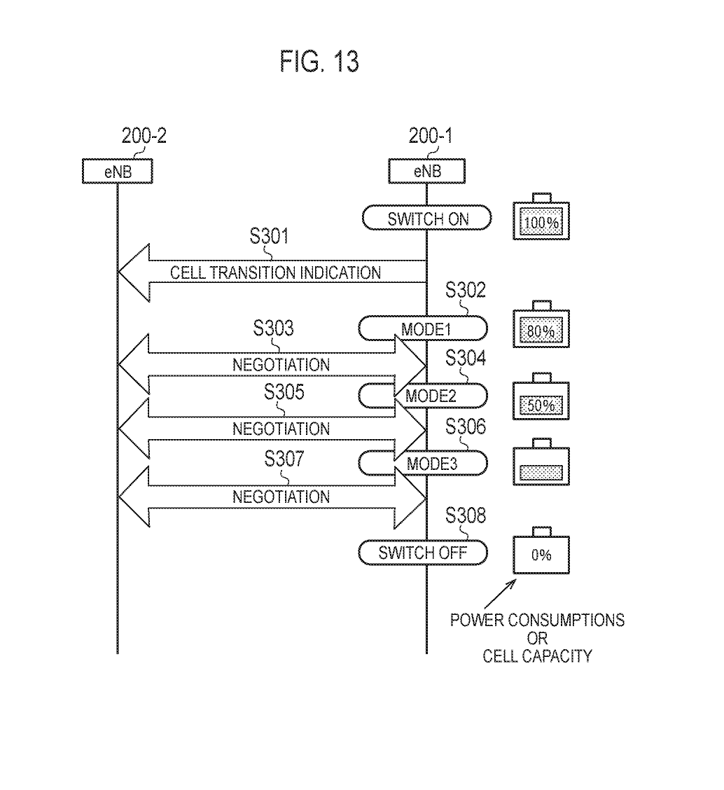

FIG. 13 is an operation sequence diagram according to the second embodiment. As described in the first embodiment, assuming that the eNB 200-1 changes the energy saving method in order, it is preferable to handover cell edge the UE while the handover parameter is updated in order. In this case, it is preferable to notify the handover parameter from the eNB 200-1 to the eNB 200-2 a plurality of times either periodically or by using a change of the energy saving method as a trigger.

In the example of FIG. 13, firstly, the eNB 200-1 transmits an energy saving transition notice (Cell Transition Indication) to the eNB 200-2 (step S301). Thereafter, upon each change of the energy saving method (steps S302, S304, S306, S308), negotiation is performed between the eNB 200-1 and the eNB 200-2 (steps S303, S305, S307). In the negotiation, the eNB 200-1 notifies the eNB 200-2 of an updated handover parameter.

### Other Embodiments

In the abovementioned embodiments, an example of a heterogeneous network consisting of the eNBs 200 of different cell types is described, but the present invention is not limited to the heterogeneous network. The present invention may be applied to a network consisting of the eNBs 200 of the same cell type.

In the abovementioned embodiments, the LTE system is described as one example cellular communication system, but the present invention is not limited to the LTE system. The present invention may be applied to a non-LTE system.

Japanese Patent Application No. 2013-164886 (filed on Aug. 8, 2013) is herein incorporated in its entirety by reference.

### INDUSTRIAL APPLICABILITY

The present invention is useful in the field of mobile communication.

1. A base station for use in a mobile communication system, comprising:
a controller configured to perform an energy saving operation for reducing power consumption of the base station while enabling communication between the base station and user terminals connected to the base station, wherein
prior to performing the energy saving operation, the controller transmits, to a neighboring base station, an energy saving transition notice that indicates transition to the energy saving operation.

2. The base station according to claim 1, wherein
the energy saving transition notice is used as a trigger for restraining handover of user terminal from the neighboring base station to the base station, at the neighboring base station.

3. The base station according to claim 1, wherein
the energy saving operation includes a transition operation that gradually reduces the power consumption of the base station while handover of the user terminals from the base station to the neighboring base station is performed in order.

4. The base station according to claim 3, wherein
after starting the transition operation, the controller ends the transition operation based on an increase in a load level of the neighboring base station and transmits, to the neighboring base station, a transition end notice that indicates an end of the transition operation.

5. The base station according to claim 4, wherein
in the energy saving operation after the end of the transition operation, the controller maintains a power consumption state of the base station as of the end of the transition operation.

6. The base station according to claim 4, wherein
the transition end notice is used as a trigger for cancelling restraint of handover of user terminal from the neighboring base station to the base station, at the neighboring base station.

7. The base station according to claim 4, wherein
in the transition operation, the controller adjusts a handover parameter to be applied to the user terminals connected to the base station and thereby in order performs handover of the user terminals from the base station to the neighboring base station.

8. The base station according to claim 7, wherein
the controller includes, in the energy saving transition notice, the handover parameter to be applied to the user terminals connected to the base station and transmits the energy saving transition notice to the neighboring base station.

9. A base station for use in a mobile communication system, comprising:
a receiver configured to receive, from a neighboring base station, an energy saving transition notice that indicates transition to an energy saving operation for reducing power consumption of the neighboring base station before the neighboring base station performs the energy saving operation while enabling commination between the neighboring base station and user terminals connected the neighboring base station.

10. The base station according to claim 9, further comprising:
a controller configured to, upon receipt of the energy saving transition notice from the neighboring base station by the receiver, perform control to restrain handover of user terminal from the base station to the neighboring base station.

11. The base station according to claim 10, wherein
the energy saving operation includes a transition operation that gradually reduces the power consumption of the neighboring base station while handover of the user terminals from the neighboring base station to the base station is performed in order, and
the receiver further receives, from the neighboring base station, a transition end notice that indicates an end of the transition operation.

12. The base station according to claim 11, wherein
the controller is configured to, upon receipt of the transition end notice from the neighboring base station by the receiver, cancel restraint of handover of user terminal from the base station to the neighboring base station.

13. The base station according to claim 10, wherein
the energy saving transition notice includes a handover parameter to be applied to the user terminals connected to the neighboring base station, and
the controller applies, to user terminal connected to the base station, the handover parameter included in the energy saving transition notice.

14. A communication control method for use in a mobile communication system, comprising:
transmitting, from a base station to a neighboring base station, an energy saving transition notice that indicates transition to an energy saving operation before the base station performs the energy saving operation, wherein
the energy saving operation is an operation for reducing power consumption of the base station while enabling commination between the base station and user terminals connected the base station.
